(19) United States
(12) Patent Application Publication
(10) Pub. No.: US 2013/0023151 A1
(43) Pub. Date: Jan. 24, 2013

(54) COAXIAL CABLE CONNECTOR WITH CONDUCTIVE SEAL

(71) Applicants: Randall A. Holliday, Broomfield, CO (US); Robert M. Parker, Aurora, CO (US)

(72) Inventors: Randall A. Holliday, Broomfield, CO (US); Robert M. Parker, Aurora, CO (US)

(73) Assignee: Belden Inc.

(21) Appl. No.: 13/479,123

(22) Filed: May 23, 2012

Related U.S. Application Data
(60) Provisional application No. 61/490,373, filed on May 26, 2011.

(51) Int. Cl. H01R 9/05

(52) U.S. Cl. 439/578

(57) ABSTRACT

A coaxial cable connector for connection to a terminal includes inner and outer spaced concentric sleeves configured to cooperate in retaining an end of a coaxial cable, at least one of the inner and outer sleeves having a flange at its forward end and a coupling member configured to draw the flange toward an end of the terminal. The coupling member and the flange have confronting surface portions therebetween. The connector further includes an annular electrically conductive member disposed between the confronting surface portions for establishing conductivity between the coupling member and the flange when the coupling member and the flange are drawn into proximity with one another.

### CROSS-REFERENCE TO RELATED PATENT APPLICATIONS

This application claims the benefit of U.S. Provisional Application No. 61/490,373, filed May 26, 2011, which is incorporated herein by reference in its entirety.

### BACKGROUND

The present disclosure relates to cable termination assemblies; and more particularly, to a novel and improved termination assembly for connecting a coaxial cable to a selected device, such as, the terminal on a home entertainment system, television set, or other device.

### SUMMARY

One embodiment relates to a coaxial cable connector for connection to a terminal comprising inner and outer spaced concentric sleeves configured to cooperate in retaining an end of a coaxial cable, at least one of the inner and outer sleeves having a flange at its forward end; a coupling member configured to draw the flange toward an end of the terminal, wherein the coupling member and the flange having confronting surface portions therebetween; and an annular electrically conductive member disposed between the confronting surface portions for establishing conductivity between the coupling member and the flange when the coupling member and the flange are drawn into proximity with one another.

Another embodiment relates to a coaxial cable connector for connection to a terminal comprising inner and outer spaced concentric sleeves configured to cooperate in retaining an end of a coaxial cable, the inner concentric sleeve provided with a radially outwardly directed flange at its forward end; a coupling member for drawing a first annular end of the outwardly directed flange toward a second annular end of the terminal, the coupling member including a radially inwardly directed flange between a forward end of the outer concentric sleeve and the outwardly directed flange of the inner sleeve, the inwardly and outwardly directed flanges having confronting surface portions defining an annular recess therebetween; and an annular electrically conductive member disposed in the recess and being compressible between the confronting surface portions when the inwardly and outwardly directed flanges are drawn into flush engagement with one another.

Another embodiment relates to a coaxial cable connector for connection to a terminal comprising inner and outer spaced sleeves configured to cooperate in retaining an end of a coaxial cable, the inner sleeve provided with a radially outwardly directed first flange, the outer sleeve provided with a radially outwardly directed second flange; a coupling member comprising an inwardly directed flange disposed at least partially between the first and second flanges; an annular electrically conductive sealing member disposed between the first flange and the inwardly directed flange of the coupling member and configured to maintain electrical conductivity between the inner sleeve and the coupling member; and a resilient conductive member disposed between the second flange and the inwardly directed flange of the coupling member and configured to maintain electrical conductivity between the outer sleeve and the coupling member.

### BRIEF DESCRIPTION OF THE DRAWINGS

The present disclosure will become more readily appreciated and understood from a consideration of the following detailed description of various embodiments of the present invention when taken together with the accompanying drawings, in which:

FIG. 1 is a longitudinal section view of one embodiment with a cable and seal in a loosely assembled position;

FIG. 2 is an enlarged view in section of the conductive seal of FIG. 1 in a loosely assembled position prior to installation according to an exemplary embodiment;

FIG. 3 is another enlarged sectional view in detail of the conductive seal of FIG. 1 in a fully tightened position according to an exemplary embodiment;

FIG. 4 is a longitudinal sectional view of another embodiment utilizing a conductive spring member and illustrating the cable in an assembled position;

FIG. 5 is a cross-sectional view taken about lines 5-5 of FIG. 4 according to an exemplary embodiment;

FIG. 6 is an enlarged view in detail of the spring member of FIG. 4 shown in a tightly assembled position according to an exemplary embodiment;

FIG. 7 is another sectional view in detail of the spring member of FIG. 4 in a loosely assembled position according to an exemplary embodiment;

FIG. 8 is a longitudinal section view of still another embodiment utilizing a flat spring as a conductive member and being shown in a fully assembled position;

FIG. 9 is a cross-sectional view taken about lines 9-9 of FIG. 8 according to an exemplary embodiment;

FIG. 10 is an enlarged sectional view in detail of the seal and spring in a tightly assembled position according to an exemplary embodiment; and

FIG. 11 is another enlarged sectional view in detail of the seal and spring of FIG. 8 in a loosely assembled position according to an exemplary embodiment.

### DETAILED DESCRIPTION

Various embodiments disclosed herein provide for a novel and improved compression connector for cables, and specifically, for coaxial cables. For example, in F-connectors designed specifically for connection to a port or terminal of an entertainment or security system, an electrically conductive, watertight seal is disclosed herein for use in combination with an annular coupling member to maintain optimum electrical conductivity between the coaxial cable and port. In one embodiment, an electrically conductive seal is in the form of a rubber or resilient O-ring containing electrically conductive particles and is mounted so as to be compressible between a port and the end of the cable connector. In another embodiment, a conductive spring is utilized in combination with an elastomeric seal and a spring mounted between confronting surface portions of an outer connector sleeve and a coupling member. In still another embodiment, a conductive spring in the form of an arcuate band is mounted between confronting surface portions of the connector sleeve and coupling member, but spaced or removed away from the seal member.

Coaxial cables often include inner and outer concentric conductors separated by a dielectric insulator and encased or covered by an outer jacket of a rubber-like material. Numerous end connectors have been devised to effect a secure mechanical and electrical connection between a termination assembly (e.g., a coaxial cable connector) and the end of the coaxial cable, typically by having the inner conductor and dielectric insulator extend through an inner sleeve of the termination assembly while the outer conductor and jacket are inserted into an annular space between the inner sleeve and an outer sleeve. The outer sleeve is then crimped in a radially inward direction or otherwise compressed, etc. to securely clamp the end of the cable within the connector, and a fastener such as a nut on the opposite end of the connector is then connected to a port or terminal.

U.S. Pat. No. 5,975,949 illustrates a coaxial cable connector of the type described and with a somewhat modified form of watertight seal which is interposed between confronting surface portions of a flange at the end of the inner sleeve and the end of a coupling member which extends from the post or terminal. Nevertheless, in certain applications, there is a continuing need for a compression-type coaxial cable and connector which can achieve improved mechanical and electrical connection between the coaxial cable connector and the port or terminal including a novel and improved watertight but electrically conductive seal which will maintain the necessary conductivity and which is mounted in such a way as to resist accidental loosening of the coupling member between the connector and port or terminal.

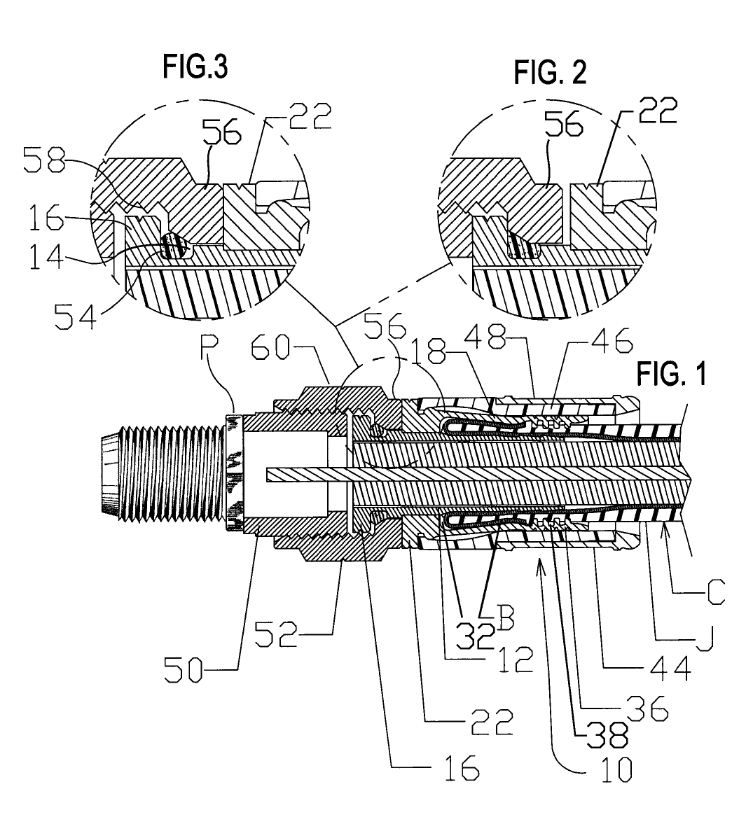

Referring in more detail to the drawings, one embodiment is illustrated in FIGS. 1 to 3 wherein the assembly is made up of an end connector 10 for connecting a first electrically conductive member, such as, a standard coaxial cable C to a second electrically conductive member, such as, a port or terminal P on different components of a home entertainment system, etc. According to an exemplary embodiment, connector 10 includes an elongated thin-walled inner sleeve 12 or post at an entrance end. In some embodiments, sleeve 12 increases in thickness along a midportion into an external groove 14 and terminates in an external shoulder 16. Connector 10 further includes an outer thin-walled sleeve 18 extending from a point slightly beyond the sleeve 12 at the entrance end, and in some embodiments being of uniform thickness along its greater length. Sleeve 18 may be provided with an external groove which is flanked at one end by external shoulder 22.

In one embodiment, inner and outer sleeves 12 and 18 extend rearwardly from the entrance end in spaced concentric relation to one another so as to form an annular space 32 therebetween for insertion of a standard cable C in a manner to be described Inner sleeve 12 may be of substantially uniform wall thickness for its greater length and have a plurality of axially spaced, annular serrations along its outer wall surface and toward the entrance end. Outer sleeve 18 may be thin-walled along its greater length, but gradually increases in thickness to define an external convex surface portion 36 and which has a plurality of axially spaced sealing rings or grooves 38 in accordance with U.S. Pat. No. 5,501,616.

According to an exemplary embodiment, a crimping ring 44 (compression member, etc.) of generally cylindrical configuration may be configured to extend over at least a portion of outer sleeve 18, and may have a length generally corresponding to the length of the thin-walled sections of outer sleeve 18. In some embodiments, member 44 includes an inner liner 46 that may be of uniform thickness and diameter throughout which terminates in opposed beveled ends, and an outside band 48 that may be of generally uniform thickness and diameter throughout at least a portion of its length and may be coextensive with inner liner 46. In some embodiments, inner liner 46 is composed of a material having a slight amount of give or resilience; and outer band 48 is composed of a material having little or no give or compressibility, such as, a brass material Inner liner 46 and band 48 may in some embodiments be of substantially corresponding thickness, and inner liner 46 may be mounted in a press-fit or other fashion inside of band 48, with its inner wall surface being of a diameter corresponding to or slightly greater than the outer diameter of outer sleeve 18 at its entrance end Inner liner 46 may in some embodiments have an inner diameter less than the convex surface portion 36 on outer sleeve 18 so that when ring 44 is axially advanced, ring 44 will impart inward radial deformation to the convex surface portion of outer sleeve 18 causing it to be contracted, as illustrated in FIG. 1, into engagement with the cable C.

The cable C is connected to the connector 10 in the usual manner by first preparing the leading end of the cable to fold the braided layer B over the end of the jacket J, as illustrated in FIG. 1. Compression ring 44 is aligned, as illustrated in FIG. 1, with the end of connector 10, following which the leading end of cable C is advanced through compression ring 44 and into annular space 32 formed between inner sleeve 12 and outer sleeve 18. A standard compression tool may be used to impart sufficient axial force to advance compression ring 44 over convex surface portion 36 to radially deform or contract that portion of sleeve 18 inwardly, and portion 36 will be bowed or deformed, etc. in a radially inward direction, as shown in FIG. 1, and cause jacket J, as well as at least a portion of braided layer B, to be compressed slightly between inner and outer sleeves 12 and 18. Once the installation is completed, a starter guide, if used, may be removed from the end of the pin conductor and discarded. A compression tool (not shown) is shown and described in detail in U.S. Pat. No. 6,708,396 which is incorporated by reference herein. While the Figures herein generally show a compression member moving axially over a compressible outer sleeve to secure a coaxial cable relative to the coaxial connector, other forms of securing the cable may be used, such as a deformable locking sleeve being axially compressed within a connector body to similarly secure the coaxial cable in position. All such alternative embodiments are to be understood to be within the scope of the present disclosure.

Port or terminal P may have a hollow externally threaded extension 50 to receive the inner conductor pin of the cable C and is coupled to the end of the connector 10 by a coupling member, such as, a nut 52 which is internally threaded with threads 58 to mate with the external threading on extension 50 whereby to draw extension 50 toward and/or into engagement with flange 16 on the end of inner sleeve or post 12 of connector 10. In order to provide for improved conductivity between connector 10 and port P, and in particular to maintain the necessary conductivity notwithstanding a poor connection or loosening of the coupling members between the conductor pin and port P, an electrically conductive, watertight annular seal 54 (e.g., a conductive o-ring, resilient member, elastomeric member, etc.) may mounted in a groove 14 adjacent to flange 16 and coupling member 52. Coupling member 52 may extend forwardly from an end wall 56 over and beyond flange 16, and may be internally threaded to facilitate connection to extension 50 of the port P. Exterior surface 60 of coupling member 52 may be provided with suitable flats (e.g., a generally hexagonal configuration, etc.) for engagement by a wrench or other suitable tool to rotate coupling member 52 independently from the remainder of connector 10.

According to an exemplary embodiment, seal 54 may take the form of an o-ring, and may be composed of an elastomeric material having electrically conductive particles uniformly or non-uniformly distributed within seal 54, one example of such particles being carbon fibers. In the loosely assembled position shown in FIGS. 1 and 3, seal 54 is in a relaxed state and not necessarily in direct contact with the adjacent or confronting surfaces of the flange 16 and end wall 56 of the coupling member 52. However, when the coupling member 52 is rotated to draw the port into contacting relation to the forward end of flange 16 opposite to seal 54, end wall 56 will be drawn toward the opposite surface of flange 16 to compress the seal 54 between the end wall 56 and flange 16, as shown in detail in FIGS. 2 and 3. As a result, a conductive path is established between inner sleeve 12 and end wall 56 of coupling member 52. It will be appreciated that seal 54 will maintain the necessary contacting relationship between the confronting surfaces notwithstanding a slight loosening between the parts, such as, as a result of temperature changes or wear. An important advantage of utilizing a watertight, conductive seal as one member or unit is that it serves a dual function of providing a watertight seal which is also electrically conductive; and at the same time the seal diameter may be varied to compensate for differences in connector size and the gap between the confronting surfaces of flange 16 and end wall 56, as well as variations in type of connector.

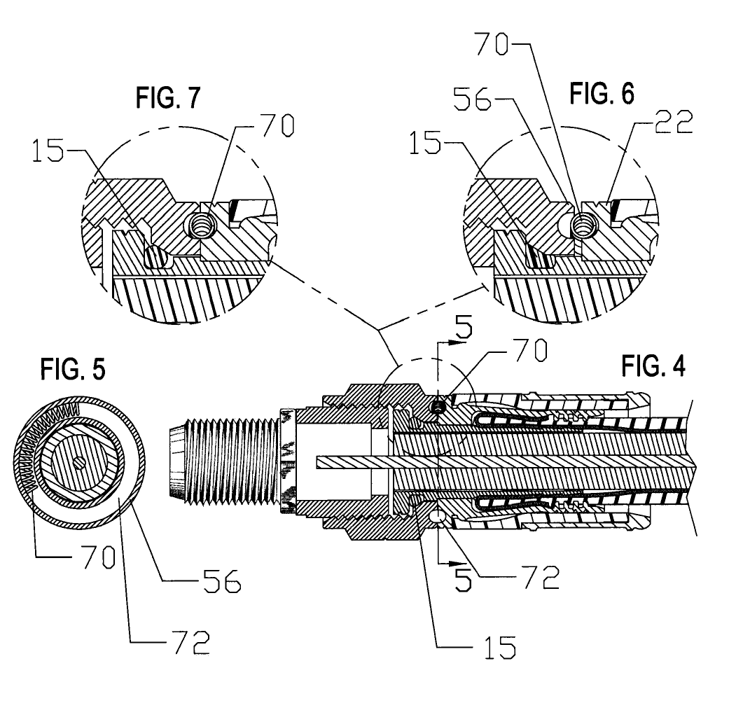

FIGS. 4-7 illustrate another embodiment of an electrically conductive compressible member in the form of a coil spring 70, which may be mounted under compression in a recessed area or gap 72 between end wall 56 and external shoulder 22 at an end of outer sleeve 18 of connector 10, as illustrated in FIGS. 4-7. According to an exemplary embodiment, shoulder 22 has a squared end surface in normally abutting relation to a squared end surface on end wall 56 of coupling member 52. In some embodiments, rather than to replace a standard 0-ring seal 15, spring coil 70 may be mounted under compression within the complementary recessed portions that define gap 72 between the respective confronting surface portions of end wall 56 of coupling member 52 and shoulder 22 of outer sleeve 18. As best seen from the end view of FIG. 5, it is not necessary for the spring 70 to extend around the entire circumference of the connector body to maintain electrical conductivity between outer sleeve 18 and coupling member 52. However, spring 70 may be of a diameter and under sufficient compression to expand and to maintain electrical contact between sleeve 18 and coupling member 52 (e.g., between the confronting surfaces of sleeve 18 and coupling member 52) notwithstanding slight separation between them, for example, as shown in FIG. 6.

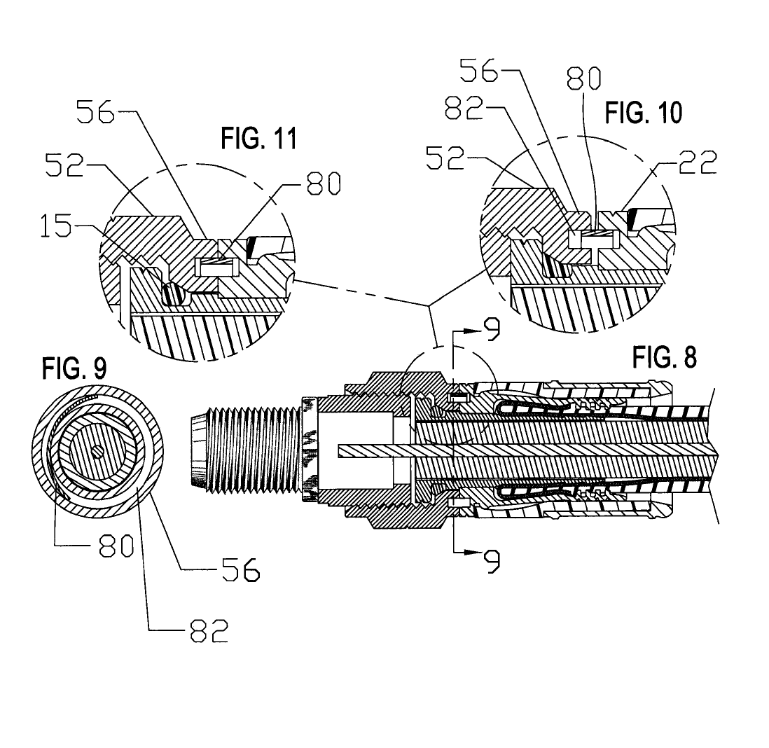

Another embodiment of a conductive ring is illustrated in FIGS. 8-10, wherein like parts to those of FIGS. 1-7 are correspondingly enumerated, and, in a manner similar to that described in connection with the embodiment of FIGS. 4-7, a spring-like, generally circular band 80 may be mounted in a gap 82 defined by annular recessed portions in facing relation to one another in external shoulder 22 of outer sleeve 18 and end wall 56 of coupling member 52. According to an exemplary embodiment, band 80 may be composed of a resilient electrically conductive material such as a metal which is normally flat, but when inserted into gap 82 may be bent, as illustrated in FIG. 9, so that opposite ends of band 80 yieldingly engage circumferentially spaced surface portions of the outer wall of gap 82, and an intermediate portion of band 80 is in contact with the inner wall of gap 82. Also, band 80 may be of a width sufficient to extend along a substantial portion of the width of gap 82. As illustrated in FIG. 10, in some embodiments, band 80 will maintain electrical conductivity between outer sleeve 18 and coupling member 52 notwithstanding separation between the components; and when member 52 is adjacent the end of the sleeve 18, as shown in FIG. 11, band 80 will traverse a substantial width of gap 82.

According to alternative embodiments, the conductive ring members 70 and 80 could be composed of various materials or composite materials which would offer the same characteristics of resiliency and conductivity. For example, one or both of members 70 and 80 could be composed of an inner matrix of plastic with an outer coating of a conductive material, such as, the carbon fibers referred to in connection with FIGS. 1-3. As in the case of helical spring member 70, band 80 does not have to extend throughout the entire annular gap, for example, as illustrated in FIG. 9. In this respect, band 80 would assume a somewhat arcuate configuration when inserted into the gap between the confronting surface portions of the shoulder 22 and end wall 56.

Although the different forms of connector sleeves are illustrated for use in F-connectors as in FIGS. 1 to 11, it will be apparent that they are readily conformable for use with other types of connectors, such as, but not limited to BNC and RCA connectors. It is therefore to be understood that while selected forms of invention are herein set forth and described, the above and other modifications may be made therein without departing from the spirit and scope of the invention as defined by the appended claims and reasonable equivalents thereof

What is claimed is:

1. A coaxial cable connector for connection to a terminal comprising:
inner and outer spaced concentric sleeves configured to cooperate in retaining an end of a coaxial cable, at least one of the inner and outer sleeves having a flange at its forward end;
a coupling member configured to draw the flange toward an end of the terminal, wherein the coupling member and the flange having confronting surface portions therebetween; and
an annular electrically conductive member disposed between the confronting surface portions for establishing conductivity between the coupling member and the flange when the coupling member and the flange are drawn into proximity with one another.

2. The connector of claim 1 wherein the inner sleeve comprises the flange, and wherein the electrically conductive member comprises an elastomeric material containing electrically conductive particles.

3. The connector of claim 2 wherein the electrically conductive particles are composed at least in part of carbon fibers.

4. The connector of claim 1 wherein the outer sleeve comprises the flange, and wherein the electrically conductive member comprises a spring mounted between the coupling member and the flange.

5. The connector of claim 4 wherein the spring is a flat spring extending between the confronting surface portions.

6. The connector of claim 4 wherein the spring is a coil spring extending circumferentially between the confronting surfaces.

7. A coaxial cable connector for connection to a terminal comprising:
inner and outer spaced concentric sleeves configured to cooperate in retaining an end of a coaxial cable, the inner concentric sleeve provided with a radially outwardly directed flange at its forward end;
a coupling member for drawing a first annular end of the outwardly directed flange toward a second annular end of the terminal, the coupling member including a radially inwardly directed flange between a forward end of the outer concentric sleeve and the outwardly directed flange of the inner sleeve, the inwardly and outwardly directed flanges having confronting surface portions defining at least in part an annular recess therebetween; and
an annular electrically conductive member disposed in the recess and being compressible between the confronting surface portions when the inwardly and outwardly directed flanges are drawn into flush engagement with one another.

8. The connector of claim 7 wherein the electrically conductive member is composed of an elastomeric material containing electrically conductive particles.

9. The connector of claim 8 wherein the electrically conductive particles are composed at least in part of carbon fibers.

10. The connector of claim 7 wherein the electrically conductive member is a spring mounted in the recess.

11. The connector of claim 10 wherein the spring is a flat spring extending about at least a portion of the recess.

12. The connector of claim 10 wherein the spring is a coil spring extending circumferentially within the recess.

13. A coaxial cable connector for connection to a terminal comprising:
inner and outer spaced sleeves configured to cooperate in retaining an end of a coaxial cable, the inner sleeve provided with a radially outwardly directed first flange, the outer sleeve provided with a radially outwardly directed second flange;
a coupling member comprising an inwardly directed flange disposed at least partially between the first and second flanges;
an annular sealing member disposed between the first flange and the inwardly directed flange of the coupling; and
a resilient conductive member disposed between the second flange and the inwardly directed flange of the coupling member and configured to maintain electrical conductivity between the outer sleeve and the coupling member.

14. The connector of claim 13 wherein the annular sealing member comprises an elastomeric material containing electrically conductive particles.

15. The connector of claim 14 wherein the electrically conductive particles are composed at least in part of carbon fibers.

16. The connector of claim 13 wherein the resilient conductive member comprises a spring disposed in a recess defined by the second flange and the inwardly directed flange of the coupling member.

17. The connector of claim 13 wherein the spring is a flat spring extending at least partially about the recess.

18. The connector of claim 13 wherein the spring is a coil spring extending circumferentially within the recess.

19. The connector of claim 13 wherein the annular sealing member comprises an electrically conductive o-ring, and wherein the resilient conductive member comprises a spring extending only partially about an annular recess defined by the second flange and the inwardly directed flange of the coupling member.

20. The connector of claim 13, wherein the outer sleeve is a deformable sleeve.
